(19) United States
(12) Patent Application Publication
(10) Pub. No.: US 2020/0031999 A1
(43) Pub. Date: Jan. 30, 2020

(54) Hybrid Organic-inorganic Polymeric Matrix in Light Valve Devices and Method for Making the Same

(71) Applicant: 1-Material Inc., Doval (CA)

(72) Inventors: Dawei Zhang, Lachine (CA); Yanan Li, Montreal (CA); Shiyong Zhao, LongVeuil (CA); Shuyong Xiao, St-Laurent (CA)

(73) Assignee: 1-Material Inc., Dorval (CA)

(21) Appl. No.: 16/047,146

(22) Filed: Jul. 27, 2018

(51) Int. Cl. C08G 77/42; G02F 1/00

(52) U.S. Cl. CPC C08G 77/42; C08G 77/70; G02F 1/0018

(57) ABSTRACT

Provided herein is an improved organic-inorganic hybrid polymeric matrix for use in light valve devices and a process to make the same. The disclosed polymer contains organic-inorganic bulky groups in the polymer backbone or as endcap group and has a general formula:

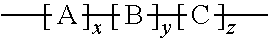

wherein:
A is a bulk group, comprising at least one Polyhedral Oligomeric Silsesquioxanes (POSS) compounds of Formula-1, where R₁ to R₈ are substitutes independently selected from hydroxyl, halide atom, saturated or unsaturated hydrocarbons

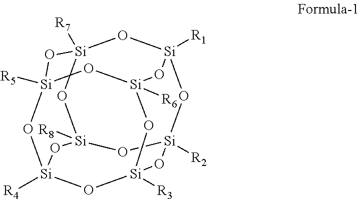

serving as a positional anchor for the polymer. B is a cross-linkable group includes at least one silicon-containing cross-linkable monomer. C represents any non-cross-linkable silicon monomer or oligomer and a combination of both monomer and oligomer and x, y, z are positive integers, where x, y, z is equal or greater than 1. These integers determine the configuration of such a hybrid organic-inorganic polymer system as expressed in the above formula.

### FIELD OF THE INVENTION

The invention is directed to a hybrid organic-inorganic polymeric matrix for use in light valve devices. The invention also relates to a method for making the same. The light controlling films made from the hybrid organic-inorganic polymeric matrix of the present invention exhibits high thermal stability, high adhesion to common substrate, good moisture resistance and high structural strength.

### BACKGROUND ART

Technically, light valve is a device which can regulate the amount of light passing through a media like a water valve which can control the water flow. Window shade can be viewed as a light valve too. But in this invention, the light valve is referred a device which can electronically control the light transmittance, and such a device is scientifically referred as an electrochromic device. Depending on science behind an electrochromic device, it can be further classified as polymer dispersed liquid crystal (PDLC), electrochemical device (EC) and suspension particle display (SPD).

In practice, all the above three classes of electrochromic devices are assembled by sandwiched an electric active component between two transparent electrodes. In the case of PDLC, the electric active component is a kind of liquid crystal which transforms its crystal structure in an electromagnetic field applying via two transparent electrodes such as the device disclosed in U.S. Pat. No. 3,585,381; in the case of EC, the electric active component is a kind of chemical which undergoes redox reaction in an electromagnetic field applying via two transparent electrodes such as the device disclosed in U.S. Pat. No. 9,581,877; and in the case of SPD, the electric active component is a kind of particle which can re-orient in an electromagnetic field applying via two transparent electrodes such as the device disclosed in U.S. Pat. Nos. 8,059,331 and 9,638,979. Hereinafter, the light valve in this invention is specifically related to SPD type electrochromic device.

A typical SPD is made by sandwiching a light control layer between transparent electroconductive substrates, referred as transparent electrodes. The light control layer is generally obtained by dispersing a light control suspension which contains light control particles into a resin matrix, wherein the light control particles respond to an electric field. More specifically in this kind of light valve, the light control particles absorb, scatter or reflect light by Brownian motion in the state that no electric field is applied thereto; thus, incident light into the film cannot penetrate through the film. When an electric field is applied thereto, the light control particles are oriented in the direction parallel to the electric field by the polarization of the particles; thus, incident light to the film can penetrate through the film. Therefore, in such a light valve, the amount of transmitted light is adjusted in accordance with the response of light control particles to an electric field.

Structurally, this SPD light valve is typically a polymeric matrix in solid form which contains droplets of the light control suspension in liquid form, and inside these droplets the light control particles in solid form of certain shape and size are embedded, To simplify the description of this SPD system in the text of this invention, polymeric matrix is referred as polymeric matrix (PM), the liquid suspension making up the droplets is referred as suspension medium (SM) and the light controlling particles encapsulated inside the SM is referred as light control particles (LCP). In practice, the solid form of polymeric matrix is mostly formed by polymerization of the corresponding monomers or oligomers, referred as precursors of PM (PPM) by photo-polymerization; thus an emulsion containing PPM, SM, LCP and photo initiator (PI) is formulated such that this emulsion can be coated onto a transparent electrode by tradition coating methods including doctor-blade coating, screen printing, slot-die coating, and then the wet coated layer is subsequently solidified (or named cured) by exposure to a ultraviolet (UV) irradiation.

Although the light valve in a film form (referred as LV Film) of SPD type has been successfully developed for many years, some notable deficiencies have been limited its wide deployment in commercial applications. One of these notable deficiencies is that the cured polymeric matrix film bonds insufficiently strong to the transparent electrodes, such as an ITO/PET substrate, and as such the device can be subjected to loss of its structure integral due to peeling; bending, folding, and friction. The U.S. Pat. No. 7,791,788 disclosed that addition of (3-glycidoxypropyl) methyl dimethoxy silane into a polymeric matrix can improve the adhesion between the cured polymeric matrix and transparent electrodes, but the obtained result was not satisfactory. A second deficiency is that the LV films disclosed in prior arts generally lack sufficient moisture resistance. When these LV films are exposed to a high humidity environment, the color of films would fade quickly because water can degrade or even destroy nano-structure of LCP, and evenly cause the dis-function of LV films. Thirdly, the residual of photoinitiator remained inside the cured LV films presents another potential danger to the stability of the LV film, and indeed a LV film of high concentration of photoinitiator residue can turn red when it is exposed to the sun light for certain period, and even worse for these LV films without U-protection layer.

Therefore, it is highly desirable to develop a LV film in which the cured polymeric matrix is capable of bonding better onto the selected transparent electrodes, capable of providing better moisture resistance to protect LCP, and with less amount of photoinitor residue. This is the objective of the present invention.

### SUMMARY OF THE INVENTION

Provided herein is an improved organic-inorganic polymeric matrix for IN films. Herein, the organic part is presented by a family of carbon-based molecular moieties; and the inorganic part is specifically presented, by a chemical class of molecular silica, more specifically, Polyhedral Oligomeric Silsesquioxanes (POSS) compounds which consist mainly of silica core as illustrated in Formula-1, where R₁ to R₈ are substitutes independently selected from hydroxyl, halogen

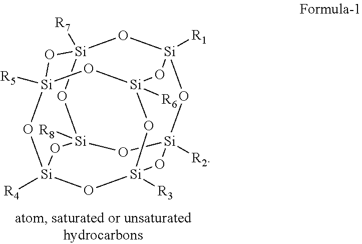

In this invention, the inventors demonstrate how to obtain, polymeric matrix based on. POSS segments and cross-linkable monomer or oligomer and non-cross-linkable monomer or oligomer. The POSS segments are either on the polymer backbone or as endcap groups. The polymeric matrix containing POSS increases the decomposition temperature and glass transition temperature, reduces flammability and heat evolution, and enhances mechanical and physical properties as well. Practically, these enhancements result from POSS's ability to control the motion of the chains while still maintaining the processability and mechanical properties of original polymeric matrix as evidenced in U.S. Pat. No. 6,900,923 here incorporated as a reference. Scientifically, these enhancements are direct results of POSS's silsesquioxane cage structure with similarities to both silica and silicone; and POSS's capability to bond to organic molecules and to one another, forming large chains that weave through the polymer which, act like nanoscale reinforcing fibers.

More specifically, the present invention discloses a family of POSS containing organic-inorganic hybrid polymeric matrix for application in LV devices. Also, this invention teaches the process for preparation of such a family of POSS containing organic-inorganic hybrid polymeric matrix. The POSS as a bulky group can be presented in the polymer backbone or as an endcap unit to the polymer chain, hence the disclosed POSS containing organic-inorganic hybrid polymeric matrix can be represented by a general Formula-2:

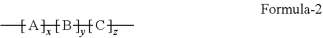

wherein: A is a bulk group, comprising at least one POSS unit as presented in Formula-1, serving as a positional anchor for the polymer. B is a cross-linkable group includes at least one silicon-containing cross-linkable monomer; C represents any non-cross-linkable silicon monomer or oligomer and a combination of both monomer and oligomer and x, y, z are positive integers, where x, y, z is equal or greater than. 1.

When A is in one end of the chain, it can be viewed as one-end anchored, the configuration is

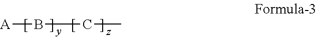

wherein: A is a bulk group, comprising at least one POSS unit as presented in Formula-1, serving as a positional anchor for the polymer, B is a cross-linkable group includes at least one silicon-containing cross-linkable monomer. C represents any non-cross-linkable silicon monomer or oligomer and a combination of both monomer and oligomer and x, y, z are positive integers, where x, y, z: is equal or greater than 1.

When A is in both end of the chain, it can be view as both-end anchored, the configuration is

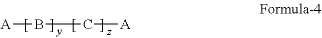

wherein: A is a bulk group, comprising at least one POSS unit as presented in Formula-1, serving as a positional anchor for the polymer. B is a cross-linkable group includes at least one silicon-containing cross-linkable monomer. C represents any non-cross-linkable silicon monomer or oligomer and a combination of both monomer and oligomer and x, y, z are positive integers, where x, y, z is equal or greater than 1.

When A is the center of the chain, it can be view as center-anchored, the configuration is Formula-5

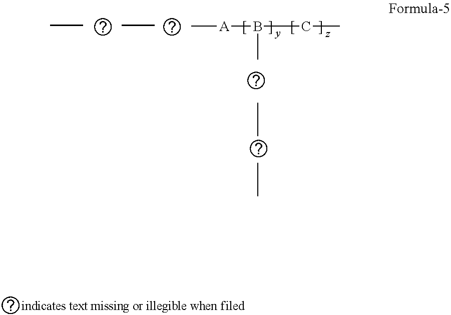

wherein: A is a bulk group, comprising at least one POSS unit as presented in Formula-1, serving as a positional anchor for the polymer B is a cross-linkable group includes at least one silicon-containing cross-linkable monomer C represents any non-cross-linkable silicon monomer or oligomer and a combination of both monomer and oligomer and x, y, z are positive integers, where x, y, z is equal or greater than 1.

The synthesis, advantages and feature of the present invention will become more apparent upon reading of the following description of the invention.

### DETAILED DESCRIPTION OF CERTAIN PREFERRED EMBODIMENTS

The key inorganic component in making the organic-inorganic hybrid polymer matrix for. PV application according to this invention is a family of Polyhedral Oligomeric Silsesquioxanes referred as POSS compounds which consist mainly of silica, core as exampled in Formula-1, where R₁ to R₈ are substitutes independently selected from hydroxyl, halogen atom, saturated or unsaturated hydrocarbons. For example, Trisilanolethyl POSS as exampled in Structure-1 is a common used POSS compound and it is used in several examples like Example 2 to 4 in this invention. The POSS may contain 1-8 silicon hydroxyl groups which is used for condensation polymerization. The ethyl group on the POSS may generally be changed to other substituted or unsubstituted monovalent hydrocarbon groups having typically from 1 to 20 carbon atoms.

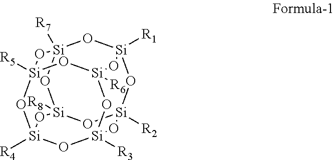

Examples of alkyl groups include methyl, ethyl, propyl, butyl, pentyl, hexyl, heptyl, octyl, cyclopentyl, groups. It may also include alkenyl group such as vinyl, allyl, hexenyl, heptenyl, octenyl, and aryl groups such as phenyl, alkylphenyl and alkoxyphenyl, Alkoxy groups include the alkyl and alkenyl groups listed above linked by an oxygen atom. The POSS which have similar structure depicted in Structure 2 to 5 are also used in synthesis like Example 5 to 8.

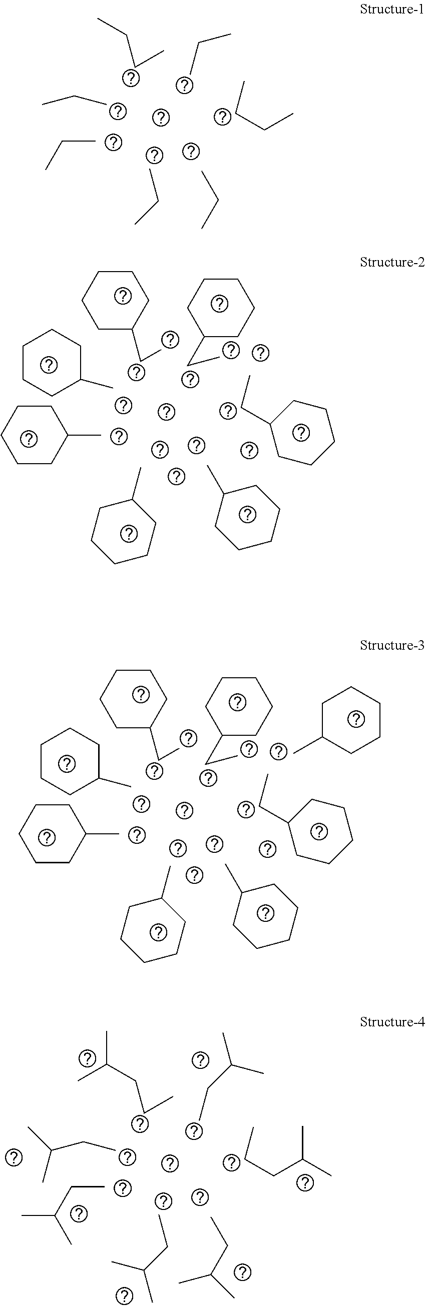

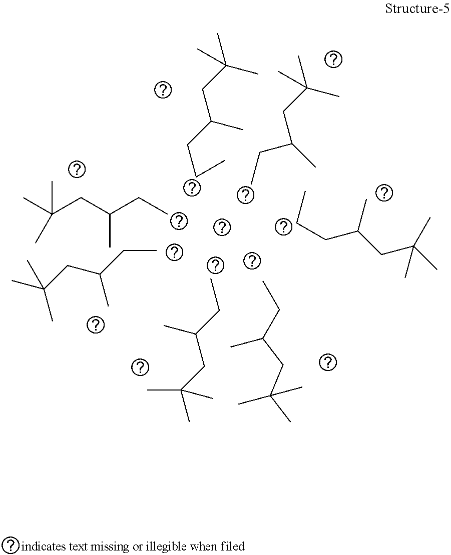

According to present invention, the BOSS units as bulky groups may present in the polymer matrix in the polymer backbone or as endcap group and having a general formula-2:

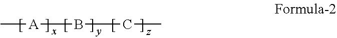

wherein: A is a bulk group, comprising at least one POSS unit as presented in Formula-1, serving as a positional anchor for the polymer. B is cross-linkable group includes at least one silicon-containing cross-linkable monomer. C represents any non-cross-linkable silicon monomer or oligomer and a combination of both monomer and oligomer and x, y, z are positive integers, where x, y, z is equal or greater than. 1.

When A is in one end of the chain, it can be viewed as one-end anchored, the configuration is Formula-3

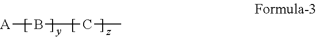

wherein: A is a bulk group, comprising at least one POSS unit as presented in Formula-1, serving as a positional anchor for the polymer. B is a cross-linkable group includes at least one silicon-containing cross-linkable monomer. C represents any non-cross-linkable silicon monomer or oligomer and a combination of both monomer and oligomer and x, y, z are positive integers, where x, y, z is equal or greater than 1.

When A is in both end of the chain, it can be view as both-end anchored, the configuration is Formula-4

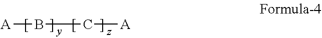

wherein: A is a bulk group, comprising at least one POSS unit as presented in Formula-1, serving as a positional anchor for the polymer. B is a cross-linkable group includes at least, one silicon-containing cross-linkable monomer. C represents any non-cross-linkable silicon monomer or oligomer and a combination of both monomer and oligomer and x, y, z are positive integers, where x, y, z is equal or greater than 1.

When A is the center of the chain, it can be view as center-anchored, the configuration is Formula-5

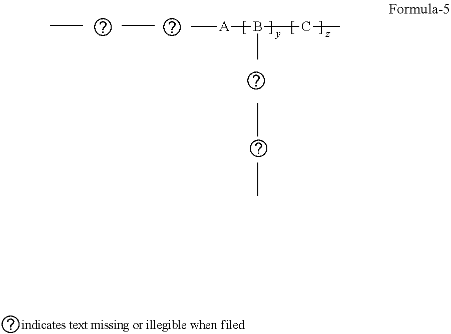

wherein: A is a bulk group, comprising at least one POSS unit as presented in Formula-1, serving as a positional anchor for the polymer. B is a cross-linkable group includes at least one silicon-containing cross-linkable monomer. C represents any non-cross-linkable silicon monomer or oligomer and a combination of both monomer and oligomer and x, y, z are positive integers, where x, y, z is equal or greater than 1.

Hereafter, the following experimental examples are provided only for the propose of illustrating the invention, and not to be constructed as limiting the invention in any manner. Example 1 below is based on U.S. Pat. No. 7,791,788 and it servers to illustrate a prior art method of synthesizing the polymeric matrix. The rest examples are directly related to the invention in all these examples, all parts and percentages are by weight unless otherwise noted. The key inorganic components in making the organic-inorganic hybrid polymer matrix is a family of POSS materials which are purchased from Hybrid Plastic, Inc, and all other chemicals are purchased from Sigma-Aldrich company unless otherwise specified.

### Example 1

### Synthesis of Siloxane Matrix Copolymer

Into a 500 ml, 3-neck round bottom flask was weighted 45 g of disilanol-terminated dimethyl diphenyl siloxane copolymer, 5 g of 3-acryloxypropylmethyl dimethoxysilane, 1 g of (3-glycidoxy propyl) methyl dimethoxysilane, and 200 ml of heptane. The flask was fitted with a Dean-Stark (“D-S”) trap and through the second port a mechanical agitation device was installed. The third port on the flask was inserted a thermometer. The contents, of the reaction flask were brought to reflux and allowed to reflux for 30 minutes without catalyst addition. Some condensation took place, as evidenced by the collection of water in the D-Strap. The catalyst, i.e., tin(II) 2-ethylhexanoate, (0.04 g) in 20 ml of heptane, was then introduced through a syringe into the flask. The reaction mixture was refluxed for additional 4 hours before adding 60 ml of a monomethoxy compound as an end-capping agent (trimethylmethoxy silane unless otherwise specified. After end-capping the reaction, the reaction mixture was cooled to room temperature for work-up.

In a typical work-up procedure, 250 ml of ethanol was placed in a 1-liter beaker and the reaction mixture was added to the beaker. The reaction flask was further washed with 30 ml of heptane and the washed liquid was also combined into the beaker. The contents of the beaker were stirred well, and 250 mL of methanol was introduced while stirring. The contents of the beaker were stirred for about 15 minutes and then transferred into a separatory funnel. Layer separation occurred after a few hours. The bottom clear layer was collected and was finally rotary evaporated to yield the target siloxane matrix polymer. In this example, total 32.4 g of the target siloxane matrix polymer was obtained.

### Example 2

### Synthesis of Improved Organic-Inorganic Polymers Containing 5% of POSS

2.7 g Trisilanolethyl POSS was dissolved into 190 ml heptane at first to prepare a POSS-contained solution. Into a 500 ml, 3-neck round bottom flask was weighted 54 g of disilanol-terminated dimethyl diphenyl siloxane copolymer and then added the above prepared. POSS-contained solution. The flask was fitted with a Dean-Stark (“D-S”) trap and through the second port: a mechanical agitation device was installed. The third port on the flask was inserted a thermometer. The contents of the reaction flask were subsequently heated to reflux for 30 minutes before addition of the catalyst (in this example, 0.13 g tin(II) 2-ethylhexanoate in 10 ml of heptane) by a syringe. After the addition of the catalyst. 3 g of 3-acryloxypropylmethyl dimethoxysilane and 1.8 g of (3-glycidoxy propyl) methyl dimethoxysilane were then slowly dropped into flask by a dropping funnel in a period of 10 minutes. The reaction mixture was refluxed for additional 5 hours before adding 60 ml of a monomethoxy compound as an end-capping agent (trimethylmethoxy silane unless otherwise specified). The end-capping was completed in 2 hours. After end-capping the reaction, the reaction mixture was cooled to room temperature for work-up.

Following the similar work-up procedure as that of Example 0.1, 250 ml of ethanol was placed in a 1-liter beaker and the cooled reaction mixture was added to the beaker and stirred. The reaction flask was washed with 30 ml of heptane and the washed liquid were also transferred to the beaker. The contents of the beaker were stirred well, and 200 mL of methanol was introduced while stirring. The contents of the beaker were stirred for about 15 minutes and transferred into a 1-liter separatory funnel. Layer separation occurred after a few hours. The bottom clear layer was collected and was finally rotary evaporated to yield the target siloxane matrix polymer. In this example, total 41.06 g of the improved organic-inorganic polymer matrix containing 10% of Trisilanolethyl POSS was obtained.

### Example 3

### Synthesis of Improved Organic-Inorganic Polymers Containing 10% of POSS

Example 3 was followed the same procedure as Example 2, except 5.4 g Trisilanolethyl POSS was used to replace 2.7 g Trisilanolethyl POSS. Finally, 41.25 g of the improved organic-inorganic polymer matrix containing 10% of Trisilanolethyl POSS was yielded.

### Example 4

### Synthesis of Improved Organic-Inorganic Polymers Containing 25% of POSS

Example 4 was followed the same procedure as Example 2, except 13.5 g Trisilanolethyl POSS was used to replace 2.7 g Trisilanolethyl POSS. Finally, 40.98 g of the improved organic-inorganic polymer matrix containing 25% of Trisilanolethyl POSS was yielded.

### Example 5

### Synthesis of Improved Organic-Inorganic Polymers Containing 5%. Of Trisilanolphenyl POSS

Example 5 was followed the same procedure as Example 2, except 2.7 g of Trisilanolphenyl POSS was used to replace 2.7 g. Trisilanolethyl. POSS. Finally, 41.56 g of the improved organic-inorganic polymer matrix containing 5% of Trisilanolphenyl POSS was obtained.

### Example 6

Synthesis of Improved organic-inorganic polymers containing 5% of Terasilanolphenyl POSS

Example 6 was followed the same procedure as Example 2, except 2.7 g of Terasilanolphenyl. POSS was used to replace 2.7 g Terasilanolphenyl POSS. Finally, 42.03 g of the improved organic-inorganic polymermatrix containing 0.5% of Terasilanolphenyl POSS was obtained.

### Example 7

### Synthesis of Improved Organic-Inorganic Polymers Containing 5% of Trisilanolbutyl POSS

Example 7 was followed the same procedure as Example 2, except 2.7 g of Trisilanolbutyl POSS was used to replace 2.7 g Trisilanolbutyl POSS. Finally, 40.38 g of the improved organic-inorganic polymer matrix containing 5% of Trisilanolbutyl POSS was obtained.

### Example 8

### Synthesis of Improved Organic-Inorganic Polymers Containing 5% of Trisilanolsooctyl POSS

Example 8 was followed the same procedure as Example 2, except 2.7 g of Trisilanolsooctyl POSS was used to replace 2.7 g Trisilanolsooctyl POSS. Finally, 40.03 g of the improved organic-inorganic polymer matrix containing 5% of Trisilanolsooctyl POSS was obtained.

### Example 9

### Testing of Improved Organic-Inorganic Polymers

The polymer matrixes prepared in the above examples were used to make the corresponding LV device samples 1-8. The general procedure to make a LV device is following:

(1) the selected photoinitiator Irgacure 81.9 with pre-determined amount (0.1% unless otherwise specified) was dissolved in the polymeric matrix.
(2) the selected LV suspension as exampled in U.S. Pat. No. 7,791,788 was then mixed with the polymeric matrix in a ratio of 1:2 to yield a LV emulsion.
(3) The LV emulsion was applied onto an ITO-coated PET plastic substrate as a 6-mil thick wet coating using a doctor blade, and then mated with a second ITO-coated PET substrate (with both ITO surfaces in contact with the emulsion) and then cured with ultraviolet radiation (6,000 mJ/cm3) to yield a 4 mil thick solid LV film.
(4) The solid LV film was electrically activated using 220 Volts AC at 50 Hz, and light transmittance was recorded before and after applying the electric voltage. Each of the films made from polymeric matrixes as examples in this invention has exhibited electrochromic behavior, with the light transmittance from about 1% in the off state to about 50% in the on state.
(5) The moisture resistance and other properties are qualitatively assessed via life-time time in an environment chamber at a humidity of 95%, temperature of 60° C., and xenon radiation of 500 watt/in². Typical observations are summarized in Table-1

TABLE 1
Typical performance of LV devices made from the exampled
polymer matrix

| | UV-Curability | Bonding Strength | Moisture Resistivity |
|---|---|---|---|
| LV-Sample | Time to cure(s) | (N/m) | (Hrs to colorless) |
| 1 | N/A | N/A | N/A |
| 1-Q* | 30 | 1.8 | 216 |
| 2 | 30 | 2.7 | 480 |
| 3 | 20 | 2.8 | 528 |
| 4 | 15 | 2.9 | 600 |
| 5 | 30 | 2.8 | 504 |
| 6 | 20 | 2.8 | 504 |
| 7 | 30 | 2.8 | 480 |
| 8 | 30 | 2.8 | 480 |

1-Q* LV sample made from polymeric matrix prepared in Example-1 but with four times amount of photoinitiator.

UV-Curability: All samples except Sample-1 made from the polymer matrix of Example 1 based on U.S. Pat. No. 7,791,788 was reasonably solidified after different UV exposing time as shown in Table 1 above. Further test showed that the polymer matrix of Example 1 required four times amount of photoiniator to be properly cured, and the sample made with four times amount of photoiniator was referred as. Sample 1-Q in Table-1. Technically; it is known that larger amount of photoiniator might cause larger amount of photoinitor residue or by-products resulted in the decomposition of the photoiniator inside the final LV film. Clearly as a polymer matrix for LV device, the improved organic-inorganic polymers made according to this invention can provide better UV-curability and reduce the amount of photoiniator usage, this in return not only reduce the cost of LV film but reduce the potential problems associated with film being cured with higher amount of photoinitiator.

Moisture resistance: The moisture resistance was indirectly evaluated from the stability test in an environmental chamber. During this test; all LV films were subjected to a high relative humidity of 95% at a temperature of 60° C. The LV Sample 1-Q which used polymer matrix from Example 1 based, on U.S. Pat. No. 7,791,788 was degraded to colorless after 21.6 hours exposure, while all the rest LV samples still exhibited light, blue color at the same time and at least doubled the time to colorless at the test conditions as listed in Table-1. Therefore, it is evidenced that LV films made from the improved organic-inorganic polymers of this invention improve the moisture resistivity.

Bonding Strength: The bonding strength of LV film to the substrate, ITO/PET in these samples herein is another important factor to check the durability of LV film, which was measured using a rheometer; STROGRAPH E-S, Toyo Seiki Seisakusho Ltd. All the LV films were tested under the conditions that peeling angle was 900, loading weight was 50N, pulling-up speed was 5.0 mm/min. The bonding strength of film using the improved organic-inorganic polymers, LV Sample 2-8, was about 2.8 N/m. As comparation, the bonding strength of the film for LV Sample 1-Q which used polymer matrix from Example 1 based on U.S. Pat. No. 7,791,788 was 1.8 N/m. The results demonstrated that the improved organic-inorganic polymers had a better bonding strength.

What is claimed is:

1. A improved polymer containing Polyhedral Oligomeric Silsesquioxanes (POSS) compounds of Formula-1, where R₁ to R₈ are substitutes independently selected from hydroxyl, halogen atom, saturated or unsaturated hydrocarbons. 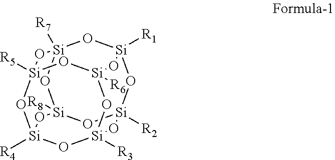
as bulky group in the polymer backbone or as endcap group and having a general Formula-2: 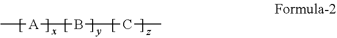
wherein:
A is a bulk group, comprising at least one POSS unit of Formula-1, serving as a positional anchor for the polymer; B is a cross-linkable group includes at least one silicon-containing cross-linkable monomer; C represents any non-cross-linkable silicon monomer or oligomer and a combination of both monomer and oligomer; and x, y, z are positive integers, where x, y, z is equal or greater than 1.

2. The said improved polymer of claim 1 wherein A is in one end of the chain, having a Formula-3 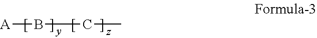
wherein: A is a bulk group, comprising at least one POSS unit as presented in Formula-1, serving as a positional anchor for the polymer; B is a cross-linkable group includes at least one silicon-containing cross-linkable monomer; C represents any non-cross-linkable silicon monomer or oligomer and a combination of both monomer and oligomer and x, y, z are positive integers, where x, y, z is equal or greater than 1.

3. The said improved polymer of claim 1 wherein A is in both end of the chain, having a Formula-4 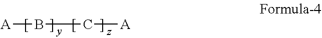
wherein: A is a bulk group, comprising at least one POSS unit as presented in Formula-1, serving as a positional anchor for the polymer; B is a cross-linkable group includes at least one silicon-containing cross-linkable monomer. C represents any non-cross-linkable silicon monomer or oligomer and a combination of both monomer and oligomer and x, y, z are positive integers, where x, y, z is equal or greater than 1.

4. The said improved polymer of claim 1 wherein A is the center of the chain, having a Formula-5 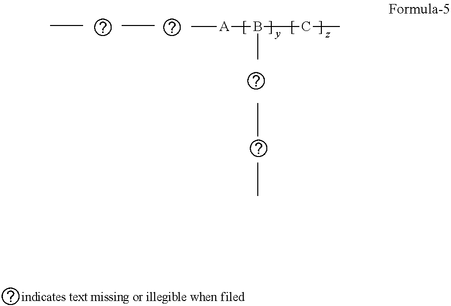
wherein: A is a bulk group, comprising at least one POSS unit as presented in Formula-1, serving as a positional anchor for the polymer. B is a cross-linkable group includes at least one silicon-containing cross-linkable monomer. C represents any non-cross-linkable silicon monomer or oligomer and a combination of both monomer and oligomer and x, y, z are positive integers, where x, y, z is equal or greater than 1.

5. A film made from the said improved polymer of claim 1

6. A film of capable of electronically changing its light transmittance made from the said improved polymer of claim 1

7. A method of making the said improved polymer of claim 1 comprising the steps of:
(a) providing a Polyhedral Oligomeric Silsesquioxanes (POSS) compounds of Formula-1, 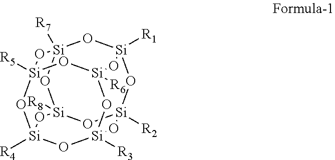
where R₁ to R₈ are substitutes independently selected from hydroxyl, halogen atom, saturated or unsaturated hydrocarbons,
and at least one cross-linkable segments and a non-cross-linkable segment;
(b) obtaining a condensation polymerization of the segments of step (a);
(c) separating the result improved polymer from solution.
